(19) United States
(12) Patent Application Publication
(10) Pub. No.: US 2011/0089591 A1
(43) Pub. Date: Apr. 21, 2011

(54) Methods and Systems for Manufacturing Composite Parts

(75) Inventors: Thomas A. Gordon, Glastonbury, CT (US); William Henry Todd, IV, West Hartford, CT (US); Herve Vincent, Alcobendas (ES); Harold L. Osthus, Willington, CT (US)

(73) Assignee: Gerber Scientific International, Inc., South Windsor, CT (US)

(21) Appl. No.: 12/904,625

(22) Filed: Oct. 14, 2010

Related U.S. Application Data
(60) Provisional application No. 61/252,464, filed on Oct. 16, 2009.

(51) Int. Cl. B29C 31/08; B29C 70/68

(52) U.S. Cl. 264/40.1; 425/169

(57) ABSTRACT

Methods and apparatuses for manufacturing a composite part are provided. One method includes cutting a material into a plurality of pieces and marking each of the plurality of pieces of material with a unique indicium. This method also includes placing one of the pieces of material in a mold cavity, detecting a signal from the indicium on the piece of material, and verifying that the piece of material was placed in the mold cavity in the correct location based on the signal from the indicium. The placing, detecting, and verifying steps are performed for each of the plurality of pieces of material. The pieces of material are then molded together to form the composite part.

### CROSS-REFERENCE TO RELATED APPLICATIONS

This application claims priority under 35 U.S.C. §119 to U.S. Provisional Patent Application No. 61/252,464, filed on Oct. 16, 2009, the contents of which are hereby incorporated by reference in their entirety.

### BACKGROUND OF THE INVENTION

A number of industries manufacture composite parts by cutting individual pieces from large rolls of material and assembling the composite part by arranging the pieces in a specific configuration within a mold cavity. For example, most related art methods of manufacturing composite wind blades, or similar tooled composite parts for various industries such as aerospace and automotive, involve cutting individual pieces from a roll of material, and then placing the individual pieces of material in a mold cavity according to a lay-up schedule. The individual pieces are then bonded together to form a laminate with multiple laminated layers. This composite part may be custom-engineered to have specific mechanical properties appropriate for its intended use.

These related art methods of manufacturing wind blades and other composite parts are predominantly manual. For example, steps from cutting the material to placing the individual cut pieces into the mold cavity may be performed manually by an operator. In composite part fabrication factories, operators typically cut the material, such as fiberglass, carbon fiber, or Kevlar, by hand or by computer cutter, and then hand-write piece numbers on the cut pieces of material. However, it may be disadvantageous to cut the pieces in the sequence in which they will be used in the mold, because this does not allow for the optimization of material use by closely packing the pieces within the roll of material. As a result, the pieces are generally cut in some other order that is better suited to maximizing the material yield. The cut pieces may then be rolled up and stored until they are needed at the mold. This requires a system of inventory storage and retrieval, which is another manual process in widespread use today. Composite wind blades or other large composite parts may incorporate 100's of cut pieces per part, which can lead to problems in identifying and locating the appropriate cut pieces at the proper time.

In addition, an important aspect of the fabrication method is the location and orientation of each individual piece of material when it is placed within the mold cavity. The integrity of a composite part design may be compromised by errors in the laminate layup process, such as a missing piece, an incorrect piece, or a piece with an improper location or orientation within the mold. Related art fabrication methods use laser projectors to project an outline of the shape of each piece at the desired location within the mold in the sequence dictated by the composite part design. An operator then acknowledges that each piece was applied properly in the mold by checking the inserted piece against the projected image. Alternatively, the operator may use a hand-held camera system to verify the material type, ply presence, sequence, location, and fiber orientation of a piece within the mold. Both of these methods require the operator to manually assess the actual placement of each piece as the pieces are placed within the mold.

Further, there is no independent verification that the correct piece was installed, the piece was installed in the correct location, the orientation of the piece was correct, the piece was installed in the correct sequence, and the orientation of the fibers within the piece was correct. The related art fabrication method discussed above is subject to operator error, because it relies on the operator's judgment to assess the placement of each piece within the mold. Because each composite part includes many layers, any errors in the placement of individual pieces are very difficult to detect after the composite part has been assembled. Any of the errors discussed above could cause the failure of the composite part. In the aerospace industry and other industries that use composite parts, the cost of failure is very high, and it is therefore important, and in some cases required, to independently validate each composite part's compliance with the design intent.

Recently, several new approaches for automating material placement in wind-blade and large aerospace part molds have been announced. Based on advanced aerospace manufacturing technology, these systems are expected to incorporate automated tape laying (ATL) or automated fiber placement (AFP) technology to directly build up material layers within a part mold, in addition to other mold preparation steps. Due to the form factor of the parts, these proposed systems will need to be very large, and it is expected that they will be costly, complex, and difficult to move. Also, these new approaches run counter to the desired wind blade industry trend of placing the blade manufacturing site near the end use site, in order to circumvent the cost and logistical complexities of transporting finished blades.

Therefore, it would be advantageous to automate many steps of the current manual manufacturing system without the substantial costs and complexity of the proposed ATL and AFP machinery. In addition, it would be advantageous to provide a method and system that could automatically validate the compliance of each composite part with the design intent. Further, it would be advantageous to develop a system that could be easily deployed at any manufacturing site.

### SUMMARY OF THE INVENTION

According to an aspect of the invention, there is provided a method for manufacturing a composite part. The method includes cutting a material into a plurality of pieces and marking each of the plurality of pieces of material with a unique indicium. The method also includes placing one of the pieces of material in a mold cavity, detecting a signal from the indicium on the piece of material, and verifying that the piece of material was placed in the mold cavity in the correct location based on the signal from the indicium. The placing, detecting, and verifying steps are performed for each of the plurality of pieces of material. The pieces of material are then molded together to form the composite part.

For each piece of material, the method may also include using light to project an outline of the piece of material onto the mold cavity, and placing the piece of material in the mold cavity within the projected outline. A portion of the light used to project the outline of the piece of material may be reflected by the respective indicium as the signal from the piece of material.

The method may also include nesting the material by a computerized nesting engine before the cutting of the material into the plurality of pieces. The nesting may include managing locations of seams within the pieces of material to be placed in the mold cavity based on a computerized design of the composite part. In addition, the method may include using an automated tracking system to identify and validate a roll of the material and verify that the material remains within its useful life before the cutting of the material into the plurality of pieces, and additionally that the cut pieces are assembled into the mold and cured before they reach the end of their useful life or accumulated time out of cold storage. Further, for each piece of material, the method may include winding the piece of material on a core tube by a multi-spindle winding machine after the cutting and marking of the piece of material.

Before the placing of the plurality of pieces in the mold cavity, the method may include determining a sequence according to which the plurality of pieces are to be placed in the mold cavity based on a computerized design. Also before the placing of the plurality of pieces in the mold cavity, the method may include locating each of the plurality of pieces of material by communicating with the respective indicia on each of the pieces of material. The cutting, marking, detecting, and verifying may be performed by a controller and may be based on a computerized design of the composite part.

Each indicium may include at least one of a symbol, a radio-frequency identification (RFID) tag, or a barcode. In addition, each indicium comprises a plurality of symbols that form a unique pattern.

For each piece of material, the method may also include verifying that the piece complies with a maximum cumulative time spent outside of cold storage, based on the signal from the respective indicium. The marking may include applying the respective indicium in registration with a geometry of the piece. Each of the plurality of pieces may be marked with the respective indicium before or after the material is cut into the plurality of pieces.

The method may also include recognizing that a piece of material was placed in an incorrect location in the mold cavity based on the signal from the respective indicium on the piece of material; comparing the incorrect location with the correct location; and feeding back instructions for repositioning the piece of material based on the results of the comparison. In addition, the method may include removing a protective layer on which the indicium was applied after verifying that the piece of material was placed in the mold cavity in the correct location for each piece of material; and scanning the mold cavity to verify that the protective layer was removed. Alternatively, top or bottom protective layers can be scanned after their removal from the cut pieces and logged to verify their removal from the mold.

According to another aspect of the invention, there is provided a method of validating a placement of a piece of material within a mold cavity. The method includes marking the piece of material with an indicium; placing the piece of material in the mold cavity; detecting a signal from the indicium; and verifying that the piece of material was placed in the mold cavity in a correct location based on the signal from the indicium.

The method may also include verifying that the piece of material was placed in the mold cavity with a correct orientation with respect to the mold cavity based on the signal from the indicium. In addition, the method may include verifying that the piece of material was placed in the mold cavity with a correct fiber orientation based on the signal from the indicium. Further, the method may include verifying that the piece of material was placed in the mold cavity in a correct sequence with respect to other pieces of the material based on the signal from the indicium. Additionally, the method may include verifying that the piece of material complies with a maximum cumulative time spent outside of cold storage based on the signal from the indicium.

The signal from the indicium may indicate an actual location of the piece of material, and the verifying that the piece of material was placed in the mold cavity in the correct location may include comparing the actual location of the piece of material with a target location of the piece of material based on a design of the composite part. The target location may be stored within the indicium.

According to yet another aspect of the invention, there is provided a system for manufacturing a composite part. The system includes a cutter that cuts pieces of material; an applier that applies a unique indicium to each piece of material; a projector that projects an outline of each piece of material onto a mold cavity; a detector that receives a signal from the respective indicium on each piece of material; and a processor that analyzes the signals to verify that each piece of material was placed in the mold cavity in a correct location.

The system may also include a multi-spindle winding machine that is coordinated with an output of the cutter and that winds each piece of material on a core tube. The applier may include at least one of a printer that applies the respective indicium directly to the piece of material, or a labeler that applies a label (visual or RFID) on which the respective indicium is printed to the piece of material.

According to a further aspect of the invention, there is provided a system for manufacturing a composite part. The system includes means for cutting pieces of material; means for applying a unique indicium to each piece of material; means for projecting an outline of each piece of material onto a mold cavity; means for receiving a signal from the respective indicium on each piece of material; and means for analyzing the signals to verify that each piece of material was placed in the mold cavity in a correct location.

According to a further aspect of the invention, there is provided a computer-readable medium comprising computer instructions executable by a processor to cause the processor to perform a method of validating a placement of a piece of material within a mold cavity. The method includes marking the piece of material with an indicium; detecting a signal from the indicium after the piece of material has been placed in the mold cavity; and verifying that the piece of material was placed in the mold cavity in a correct location based on the signal from the indicium.

Other objects, advantages, and novel features of the present invention will become apparent from the following detailed description of the invention when considered in conjunction with the accompanying drawings.

### BRIEF DESCRIPTION OF THE DRAWINGS

FIG. 1 shows a manufacturing process according to an exemplary embodiment of the present invention;

FIG. 2 shows a system and a corresponding workflow according to an exemplary embodiment of the invention; and

FIG. 3 shows the Gerber Technology DCS-3600 single-ply industrial material cutter that may be used in an exemplary embodiment of the invention.

### DETAILED DESCRIPTION OF EXEMPLARY EMBODIMENTS

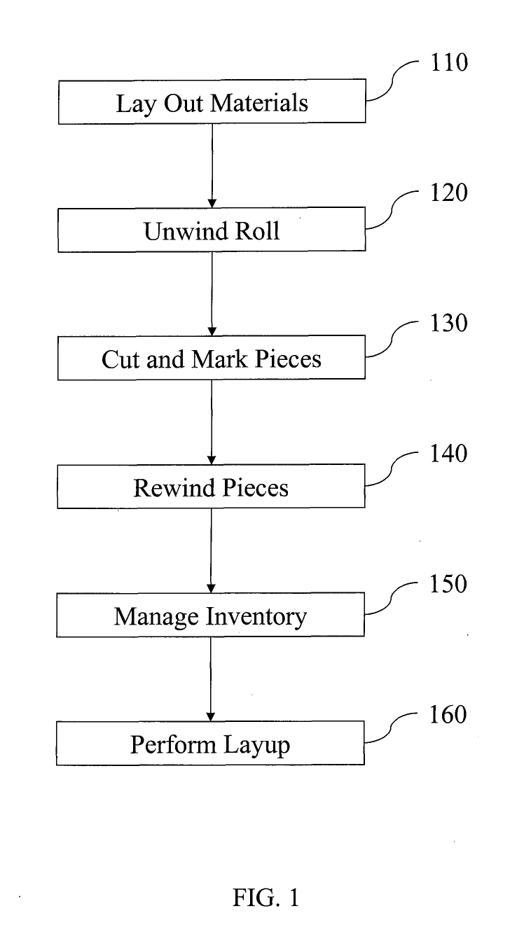

FIG. 1 shows a composite part manufacturing process according to an exemplary embodiment of the present invention. This method utilizes a two-dimensional representation of the individual layers and/or a two-dimensional representation of the individual pieces to be cut. To generate the two-dimensional representations, a three-dimensional computer-aided-design (CAD) program such as Dassault Systemes' CATIA Composites Design is typically used by the composite part designers to accurately model and predict the performance of a composite part design; however, any suitable CAD system may be used. This computer simulation of the part design is used to avoid the pitfalls that have plagued previous manual trial-and-error manufacturing processes for composite part manufacturing, such as wind blade fabrication. For example, blade failure studies performed by Sandia National Labs have revealed that manufacturing errors, including bad bonds, voids, delamination, poor laminate schedules, waviness, leading edge erosion, and trailing edge splits were responsible for a large number of required field blade replacements of wind blades that were manufactured by the manual trial-and-error wind blade manufacturing processes.

As shown in FIG. 1, the composite manufacturing process according to an exemplary embodiment of the invention begins with the layout 110 of the materials. Starting with the two-dimensional representation of individual single layer pieces, the designer or design program may dictate the material of choice based on a variety of design factors, including strength, weight, and tensile member orientation. The two-dimensional piece representations are then grouped according to the common material type and thickness of the material from which they will be cut. For example, the material may be fiberglass, carbon fiber, Kevlar, or any other material that is suitable for composite part manufacturing. The composite manufacturing process shown in FIG. 1 may also apply to core materials, such as wood or foam, that are placed between the pieces in the mold cavity to form a non-solid composite part. These core materials are typically cut with a different type of cutter, such as a router, saw, or bevel cutter. However, each of the steps of the method described herein can also be applied to the core materials.

Piece nesting, joint management, and layer management are performed during the layout 110. Nesting is an operation in which single layer pieces to be produced from the same material are grouped together to make the best possible use of the material. For example, the pieces to be cut from a particular material may be superimposed on a roll of the material, such that the portion of unused and discarded material is minimized. Nesting has a significant impact on the material yield. Because the materials typically represent a significant percentage of the cost of a composite part, it is important to control the cost of the materials. For example, in the case of wind blades, the materials might represent as much as 60% of the total cost of a blade.

Further, for structural reasons, there are some regions within a composite part where seams are allowable and other regions where seams are forbidden. A seam occurs when a piece overlaps the edge of a roll of material, such that a portion of piece is cut from the bottom edge of the roll, and the remainder of the piece is cut from the top edge of the next roll. Joint management determines where seams are located within the composite material, and prevents seams from occurring in the regions where they are prohibited. Similarly, structural considerations may prohibit coincident seams on successive layers. Layer management determines where seams are located from layer to layer.

In related art composite part manufacturing processes, many of the steps are performed manually by an operator. For example, a related art manual manufacturing process performs a manual layout that includes manual piece nesting, manual joint management, and manual layer management. However, manual nesting is labor-intensive, unreliable, and not repeatable. This leads to problems in the manual layout process, which can have a substantial impact on the final part quality and reliability. The manual layout process also suffers from the inefficiency of not predictably knowing where any given piece may cross over the end of a roll of material. For example, if a piece overlaps the edge of a roll, it may be necessary to discard the material allocated to that piece if a seam is prohibited by the joint management or layer management processes.

In contrast, according to exemplary embodiments of the invention, the layout 110 may include automated piece nesting, automated nesting of multiple rolls, automated in-process re-nesting, automated joint management, and automated layer management. The automated nesting uses computer nesting engines similar to those used in the garment industry and other industries. The automated nesting begins by superimposing the pieces called for in the computerized design over the known dimensions of the rolls of material. The computer nesting engines can run through numerous scenarios with cut piece data to optimize the use of materials by re-positioning pieces according to the design rules. Within the design rules for fiber orientation, pieces may be rotated, translated, or swapped out with other pieces, which may allow closer packing within a given roll's width and length. Automated nesting may produce significant savings in material yields, as it accounts for the shapes of pieces, as well as rules for joints and splices in material, multiple rolls, and materials with non-uniform thickness due to their multi-axial construction. Automated nesting may also perform re-nesting if the length of a roll of material is found to be different than anticipated. In addition, automated joint and splice management can establish rules to allow or disallow a seam in a specific part and/or adjust the seam location accordingly by re-nesting or shifting parts in anticipation of the roll's end.

Referring back to FIG. 1, the composite part manufacturing process then performs an unwind process 120. A related art manual process includes manually identifying a roll of material from inventory, manually validating that the proper roll is used, and manually validating that the material is within its useful life by visually checking the “use-by” date, and for pre-preg composite materials, manually recognizing the cumulative time that any given roll has been out of cold storage to comply with established limitations on elevated temperature usage prior to curing. A pre-preg material is one in which a resin is built into the material, such that the material has a limited shelf life, and may be kept at room temperature only for a limited time. The manual unwind process also requires the operator to pull a roll of material from inventory and manually unwind the roll to lay the material flat without tension or wrinkles onto a cutting table, where it is later hand-cut according to pattern templates.

In contrast, according to exemplary embodiments of the invention, the unwind process 120 may include automatically identifying a roll of material from inventory, automatically validating that the proper roll is used, and automatically validating that the material is within its useful life. The roll is automatically identified based on the job and the pieces to be cut within the computerized design. For example, a rewritable RFID chip may be placed on each roll to track the roll in real time. The RFID chip may indicate various parameters of the material, such as the remaining length of the material on the roll, material type, thickness, weight, resin properties, as well as the cumulative time that the roll has been out of cold storage. The operator may then load the validated roll into a machine that automatically unwinds the roll to coordinate with the cutter's conveyor that aligns and feeds the material.

Next, the composite manufacturing process cuts and marks the pieces of material in process 130. In a related art manual composite manufacturing process, templates are produced to serve as masters for each piece. The operator arranges these templates on top of unrolled materials, which have been laid out onto a cutting table during the unwind process 120. The pieces are then cut to the general shape of the template. During the manual cut process, individual pieces are cut by hand and then test-fit in the mold, where manual nip-and-tuck modifications take place. The manual cut process includes manually locating the proper template, manually cutting the pieces, and manually returning the template to storage. Each cut piece is later hand-marked with a piece number.

In contrast, according to exemplary embodiments of the invention, the process 130 includes automatically cutting and automatically marking each of the pieces. As described in further detail below, a controller refers to the computerized design and controls the cutter to automatically cut the appropriate pieces needed for the design. The cutter used in the automated process 130 may include an interchangeable ultrasonic cutting head to allow cutting stacks of bound and uncured materials or any number of other cutting technologies, such as reciprocating blade, rolling blade, and driven blade technologies. For example, single-ply pre-preg materials, multi-ply dry stacks, and/or multi-ply pre-preg stacks may be cut. The automated process 130 may provide high throughput and material yield, along with a repeatable piece shape.

Exemplary embodiments of the present invention may include a mechanism to automatically mark each of the pieces with a unique indicium that includes identifying information according to established rules. At least one component of the respective indicium includes information that uniquely identifies the marked piece. For example, an indicium may include a plurality of symbols, such as circular dots and/or cross hairs, that are printed as a pattern such that no two pieces have identical patterns. Alternatively, or in addition, an indicium may include an RFID tag or a barcode in which identification information is stored. The pattern and/or the identification information may be stored within a look-up table that associates the marked piece with its position within the composite part. Accordingly, each unique pattern and/or identification information is recognized by the system controller as a specific piece to be positioned at a specific location within the mold cavity. According to this method, pieces that are not cut in sequence can be automatically located and sent to the mold at the appropriate time.

The indicium may indicate the serial number, manufacturing data, and date of manufacture of the piece of material. The indicium may also indicate the piece number, the location where the piece is stored, the age of the piece, the “use by” date of the piece, the mold number, the sequence number, and the desired location and orientation of the piece within the mold. In addition, the indicium may indicate the cumulative time that the piece has been out of cold storage.

A symbol within the indicium is advantageously applied at a precise location on the piece of material such that the symbol is registered with the specific geometry of the piece of material. This provides a reference point for the location and orientation of the piece once it is placed within the mold. For example, an ink jet head may be used to mark the piece with ink on its protective backing, or where acceptable, directly on the material itself. Where there is no backing or the piece is to be marked on an exposed surface, a removable label may be used for marking to prevent contamination. The label may be pre-printed, or the label may be marked after it is applied to the piece.

According to exemplary embodiments of the invention, the piece may be cut before it is marked with the indicium. Alternatively, the piece may be marked with the indicium before it is cut from the roll of material. In this embodiment, a cutter-mounted scanning system recognizes the location of the unique indicium when the roll of material is placed on the cutter surface, and the cutter cuts the piece in exact registration with the indicium. For example, the laser projector discussed below may be used to recognize the indicium.

Referring back to FIG. 1, during the rewind process 140, the larger cut pieces are rewound onto core tubes, wound without core tubes, or left flat. In a related art manual rewind process, the cut pieces are manually labeled and manually rewound onto the core tubes. The cut pieces may be relatively tender and must be handled carefully to prevent damage and contamination. Generally, cut pieces of any appreciable size are manually wound up on core tubes, and then manually moved to storage or directly to the mold. In contrast, the automated rewind process according to exemplary embodiments of the invention replaces the manual winding of the cut pieces with an automated multi-spindle winding machine that is synchronized with the output of the cutter. The pieces are automatically marked according to a set of rules for which winding arm should be used to prevent bottlenecks at the winding station, and wound simultaneously if they were laid out in parallel. This marking may be part of the unique indicium, or an additional printed alphanumeric annotation, bar code, RFID tag, or any other visual or machine readable mark.

Once the pieces have been rewound, they may receive additional marks or labels to aid in their identification and relocation from storage. They are then placed in an inventory during process 150. The requirements for tracking the inventory are somewhat different for manufacturers utilizing pre-preg materials than for those using dry materials, due to the limited shelf life of the pre-preg materials. For example, it is advantageous to track the cumulative time that a pre-preg material has been out of cold storage. However, regardless of which type of material is used, some type of cut piece storage, inventory identification, and retrieval is required. In a related art manual inventory process, the material attributes are not tracked, which can lead to excessive labor, confusion, and a significant possibility of a lost or incorrect piece utilization that can result in a blade failure. In contrast, the automated inventory process according to exemplary embodiments of the invention provides for the automated identification and tracking of variables such as piece number, piece storage location, piece age or “use by” date, mold number, piece sequence, and generalized piece location within the mold. Specifically, the components of the printed indicium can be used to store and retrieve these variables, as well as other variables that could be added in the future.

The inventory is utilized in retrieving the pieces needed for the layup 160. A related art manual layup process includes manually determining the piece sequence, manually locating the piece to be placed from the inventory, manually identifying the desired position of the piece within the mold, manually placing the piece within the mold, and manually reporting the placement of the piece. During this process, a three-dimensional image of the two-dimensional piece may be projected into the mold by a laser projector to indicate the location for the operator to place the piece in the mold; however, the use of a laser projection system for aligning manually cut pieces does not take full advantage of the value of such a system due to the imprecision of the manually cut pieces.

In contrast, an automated layup process according to exemplary embodiments of the invention includes automatically determining the piece sequence, automatically locating the piece to be placed from the inventory, and automatically identifying the desired position of the piece within the mold. The piece sequence may be automatically determined by referring to the computerized design. The piece to be placed may be automatically located in the inventory by scanning the area where the cut pieces are stored and identifying the proper piece by receiving a signal from a component of the indicium, such as a symbol or an RFID tag. A controller may then automatically identify the desired position of the piece within the mold by controlling the laser projector to project a three-dimensional image of the two-dimensional piece into the mold. The operator then places the piece into the mold based on the guidance from the laser projector.

Once the piece has been placed within the mold, the position of the piece within the mold may be automatically detected by receiving a signal from a component of the indicium, such as a symbol or an RFID tag. For example, visible laser light from the laser projector that is reflected by a symbol on the piece that was applied as a reference point or series of points or targets may be detected to ascertain the precise location of the piece within the mold. This actual location may then be compared with the target location based on the computerized design. The target location may be stored within the indicium and/or in a computer memory that is readable by the controller. The controller may determine the direction and magnitude of the variation of the actual location from the target location, and provide this information to the operator so that the operator can move the piece to correct its position. This process may be repeated until the piece is correctly positioned at the target location.

Additional geometrical aspects may also be automatically determined based on the signal from the indicium, including the orientation of the piece with respect to the mold and the orientation of fibers within the piece. Again, the actual orientation of the piece may be compared with a target orientation based on the computerized design, and the controller may indicate how the operator should move the piece to correct the orientation. Further, additional information may be read from the symbol and/or RFID tag, such as the serial number, manufacturing data, date of manufacture, piece age or “use by” date, mold number, and piece sequence.

The indicium may be printed with ink that reflects the laser light from the projector, and a sensor may be coincident with or mounted near the laser source of the projector to detect the light reflected by the indicium. Alternatively, any other suitable technology may be used to recognize the indicium and extract its embedded information, such as RFID, ultrasound, induction, magnetism, infrared light, and/or a camera with image processing capability.

As discussed above, the automated layup process utilizes the signal from the indicium to validate that the correct piece was installed, the piece was installed in the correct location within the mold cavity, the piece was installed in the correct orientation with respect to the mold cavity, the piece was installed in the correct sequence, and the fiber orientation of the piece was correct. Once these parameters are verified as correct, the validation is logged for later reference, and the correct placement of the piece is automatically reported. Therefore, the automated composite part manufacturing process provides independent piece validation and other higher level features, while improving the accuracy and efficiency of the manufacturing process. Once each piece has been correctly positioned within the mold cavity, the pieces are bonded together to form a laminate having multiple laminated layers.

One failure mechanism of composite parts is the inadvertent failure to remove a plastic protective backing material from a cut piece. All pre-preg materials are shipped from the supplier with a plastic protective layer, which is often placed on top and bottom sides of the material. According to exemplary embodiments of the invention, the unique indicium may be printed on the top surface of the protective layer on the top side of the material. Once a piece has been placed in the mold and verified to be in the correct location, the protective layer is removed from the top side of the material. The laser projector or any other suitable component may then be used to scan the mold to confirm that the top protective layer was removed from the piece in the mold. This ensures that no top protective layers are inadvertently left on the pieces before forming the composite part.

Further, exemplary embodiments of the invention may include a method of ensuring that no bottom protective layers remain on the pieces before forming the composite part. For example, another indicium may be printed on the bottom side of the piece, or a label may be applied to the bottom side of the piece. The bottom protective layer is removed from the piece before placing the piece into the mold, and the indicium from the bottom protective layer is scanned and logged into the system to provide a record of the removal of the bottom protective layer before placing the piece into the mold. Similarly, the top protective layers can be scanned after removal from the part in the mold and logged into the system for verification to assure complete removal of all protective layers.

The composite part manufacturing process described above uses predominantly automated steps throughout the process. However, exemplary embodiments of the invention also include modifying one or more steps of a related art manual composite part manufacturing process by replacing certain manual steps with automated steps. For example, the cutting and marking of the pieces in process 130 could be automated as described above, while the rewinding 140 of the pieces is performed manually.

According to an exemplary embodiment of the invention, there is provided a computer-readable medium encoded with a computer program for manufacturing composite parts. The term “computer-readable medium” as used herein refers to any medium that participates in providing instructions for execution. Common forms of computer-readable media include, for example, a floppy disk, a flexible disk, a hard disk, magnetic tape, any other magnetic medium, a CD-ROM, any other optical medium, punch cards, paper tape, any other physical medium with patterns of holes, a RAM, a PROM, an EPROM, a FLASH-EPROM, any other memory chip or cartridge, and any other non-transitory medium from which a computer can read.

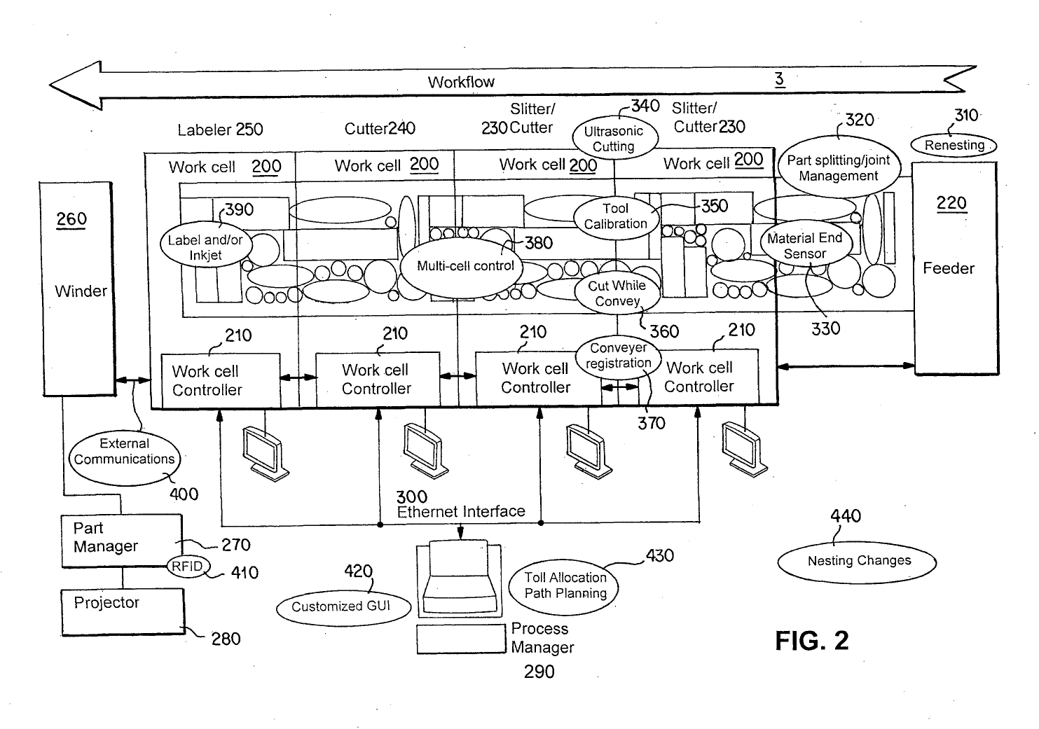

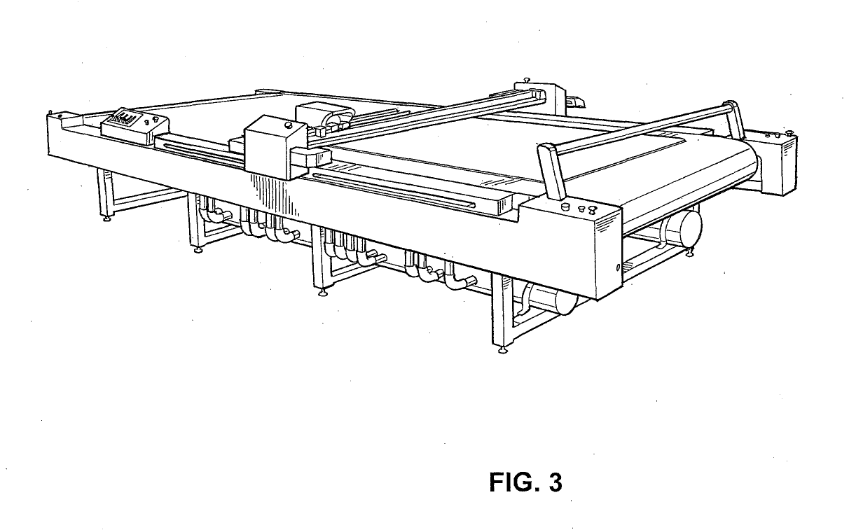

FIG. 2 shows an exemplary system in conjunction with a workflow that may be used in accordance with the present invention. As shown in FIG. 2, exemplary embodiments of the present invention may utilize a software architecture that allows incorporation of a variety of manufacturing process features necessary for automation in manufacturing wind blades or other composite parts. Various work cell functions can be linked to customer equipment for pre- and post-processing. For example, a system configuration specific to wind blade manufacturing may use a single ply cutter that incorporates a conveyor cutting bed, such as the Gerber Technology DCS-3600 shown in FIG. 3. The DCS-3600 is a single-ply conveyor material cutter configured for industrial markets.

The system architecture allows for multiple cutting stations and additional operations that may include material roll feeding (unwinding roll goods to present them in a properly aligned, stress-free condition to the cutter), piece marking (ink jet printing and/or label printing and application), and re-winding (rolling pieces onto core tubes for ease of storage and handling). For example, as shown in FIG. 2, the workflow 3 may progress through the work cells 200 from a feeder 220 to a winder 260, a part manager 270, and a laser projector 280. A process manager 290 may be connected to work cell controllers 210 within the work cells 200 via an Ethernet interface 300. The process manager 290 may include a customized GUI 420 to assist with tool allocation path planning 430. The computerized design is stored on the process manager 290 to enable the automated control of the composite part manufacturing process discussed above.

The workflow 3 may include nesting changes 440 that account for material geometric anomalies, defects, joints, and thicknesses. The workflow 3 may then proceed with renesting 310 and part splitting and/or joint management 320. A material end sensor 330 may be used before or after the cutting begins to determine the location of the end of the roll of material. Slitters or cutters 230 may perform ultrasonic cutting or other methods of cutting 340, tool calibration 350, cutting while conveying 360, and/or conveyor registration 370. The work cells 200 may have a multi-cell control 380. A label and/or inkjet printer 390 may apply the indicia to the cut pieces. External communications 400 occur between the work cells 200 and the winder 260.

Another exemplary embodiment of the present invention utilizes a modular manufacturing system architecture based on software that enables rapid deployment of new product configurations for unique new industrial market applications. This software platform may organize software into areas of commonality and variability across a set of similar products. Services or components common to a set of products form a library of mature core assets that can be reused for each new product, thereby shortening the time to market.

Architectural patterns and principles that may be employed consistently throughout the system promote reuse by making components easily connectable. A common infrastructure may provide standard mechanisms for passing information, such as synchronous and asynchronous control flow and event notifications. This software platform may allow for simple modular connectivity for any number of different peripherals to be integrated into a production manufacturing system centered on a computer-driven cutter configured for the idiosyncrasies of each new application.

For example, the modular manufacturing system may include a plurality of mechanical processing elements designed to transform materials in a continuous convey fashion. The processing elements may include one or more cutting devices for cutting textiles and other flexible materials; printers for identification of parts, colorizing, or graphic color printing; cameras, sensors, and laser projectors for edge identification, part identification, feature recognition, and part sequencing; and/or other material transport or processing elements. The process or transport elements may be configured for any number of material widths, or grouped with various elements to increase overall system throughput.

The modular manufacturing system may directly couple with an endless upstream source of material such as an extruder, in which case it may incorporate a material accumulator to allow for any time variations between material processing and upstream material feed. Alternatively, the system can process individual material elements, such as leather hides or material on rolls, with minimal roll change disruption into cut parts. In this case the modular manufacturing system could include processing mechanisms to unwind supply rolls. In either case, the system coordinates rolling of material at the output terminus.

The modular manufacturing system may incorporate a modular control to enable custom configuration of individual elements in any number or in any sequence without the need for re-writing control logic code. This control can manage data in a real-time fashion and is capable of continuous processing of variable data on unique and ever-changing input. For example, the system may custom-nest individual parts for a series of leather hides based on upstream data obtained from a scanner element within the system.

Exemplary embodiments of the present invention may provide means to address the unique requirements of the composites industry, including high volume or high throughput material handling, process management for piece identification and inventory management, optimized productivity through piece sequencing, and improved material utilization through improved nesting with sensitivity for joint and material layer management. The described methods and systems may have the hardware and software control hooks to allow integration of roll goods feeding, rewinding of cut pieces, piece marking, and inventory management. A process similar to the exemplary embodiments described above may be used to manufacture a composite material in any industry.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method of manufacturing a composite part, the method comprising:
cutting a material into a plurality of pieces;
marking each of the plurality of pieces of material with a unique indicium;
for each piece of material, placing the piece of material in a mold cavity, detecting a signal from the respective indicium, and verifying that the piece of material was placed in the mold cavity in a correct location based on the signal from the respective indicium; and
molding the pieces of material together to form the composite part.

2. The method recited in claim 1, further comprising, for each piece of material, using light to project an outline of the piece of material onto the mold cavity, and placing the piece of material in the mold cavity within the projected outline.

3. The method recited in claim 2, wherein, for each piece of material, a portion of the light used to project the outline of the piece of material is reflected by the respective indicium as the signal from the piece of material.

4. The method recited in claim 1, further comprising nesting the material by a computerized nesting engine before the cutting of the material into the plurality of pieces.

5. The method recited in claim 4, wherein the nesting comprises managing locations of seams within the pieces of material to be placed in the mold cavity based on a computerized design of the composite part.

6. The method recited in claim 1, further comprising using an automated tracking system to identify and validate a roll of the material and verify that the material remains within its useful life before the cutting of the material into the plurality of pieces.

7. The method recited in claim 1, further comprising, for each piece of material, winding the piece of material on a core tube by a multi-spindle winding machine after the cutting and marking of the piece of material.

8. The method recited in claim 1, further comprising:
before the placing of the plurality of pieces in the mold cavity, determining a sequence according to which the plurality of pieces are to be placed in the mold cavity based on a computerized design.

9. The method recited in claim 1, further comprising:
before the placing of the plurality of pieces in the mold cavity, locating each of the plurality of pieces of material by communicating with the respective indicia on each of the pieces of material.

10. The method recited in claim 1, wherein the cutting, marking, detecting, and verifying are performed by a controller and are based on a computerized design of the composite part.

11. The method recited in claim 1, wherein each indicium comprises at least one of a symbol, a radio-frequency identification (RFID) tag, or a barcode.

12. The method recited in claim 1, wherein each indicium comprises a plurality of symbols that form a unique pattern.

13. The method recited in claim 1, further comprising, for each piece of material, verifying that the piece complies with a maximum cumulative time spent outside of cold storage, based on the signal from the respective indicium.

14. The method recited in claim 1, wherein the marking comprises applying the respective indicium in registration with a geometry of the piece.

15. The method recited in claim 1, wherein each of the plurality of pieces is marked with the respective indicium before the material is cut into the plurality of pieces.

16. The method recited in claim 1, further comprising, for a piece of material:
recognizing that the piece of material was placed in an incorrect location in the mold cavity based on the signal from the respective indicium on the piece of material;
comparing the incorrect location with the correct location; and
repositioning the piece of material based on the results of the comparison.

17. The method recited in claim 1, further comprising, for each piece of material:
after verifying that the piece of material was placed in the mold cavity in the correct location, removing a protective layer on which the indicium was applied; and
scanning the mold cavity to verify that the protective layer was removed.

18. A method of validating a placement of a piece of material within a mold cavity, the method comprising:
marking the piece of material with an indicium;
placing the piece of material in the mold cavity;
detecting a signal from the indicium; and
verifying that the piece of material was placed in the mold cavity in a correct location based on the signal from the indicium.

19. The method recited in claim 18, further comprising verifying that the piece of material was placed in the mold cavity with a correct orientation with respect to the mold cavity based on the signal from the indicium.

20. The method recited in claim 18, further comprising verifying that the piece of material was placed in the mold cavity with a correct fiber orientation based on the signal from the indicium.

21. The method recited in claim 18, further comprising verifying that the piece of material was placed in the mold cavity in a correct sequence with respect to other pieces of the material based on the signal from the indicium.

22. The method recited in claim 18, further comprising verifying that the piece of material complies with a maximum cumulative time spent outside of cold storage based on the signal from the indicium.

23. The method recited in claim 18, wherein the signal from the indicium indicates an actual location of the piece of material, and the verifying that the piece of material was placed in the mold cavity in the correct location comprises comparing the actual location of the piece of material with a target location of the piece of material based on a design of the composite part.

24. The method recited in claim 23, wherein the target location is stored within the indicium.

25. A system for manufacturing a composite part, the system comprising:
a cutter that cuts pieces of material;
an applier that applies a unique indicium to each piece of material;
a projector that projects an outline of each piece of material onto a mold cavity;
a detector that receives a signal from the respective indicium on each piece of material; and
a processor that analyzes the signals to verify that each piece of material was placed in the mold cavity in a correct location.

26. The system recited in claim 25, further comprising a multi-spindle winding machine that is synchronized with an output of the cutter and that winds each piece of material on a core tube.

27. The system recited in claim 25, wherein the applier comprises at least one of a printer that applies the respective indicium directly to the piece of material, or a labeler that applies a label on which the respective indicium is printed to the piece of material.

28. A system for manufacturing a composite part, the system comprising:
means for cutting pieces of material;
means for applying a unique indicium to each piece of material;
means for projecting an outline of each piece of material onto a mold cavity;
means for receiving a signal from the respective indicium on each piece of material; and
means for analyzing the signals to verify that each piece of material was placed in the mold cavity in a correct location.

29. A computer-readable medium comprising computer instructions executable by a processor to cause the processor to perform a method of validating a placement of a piece of material within a mold cavity, the method comprising:
marking the piece of material with an indicium;
detecting a signal from the indicium after the piece of material has been placed in the mold cavity; and
verifying that the piece of material was placed in the mold cavity in a correct location based on the signal from the indicium.

30. The method recited in claim 1, further comprising:
for each piece of material, after verifying that the piece of material was placed in the mold cavity in the correct location, removing a protective layer on which the indicium was applied; and
scanning each of the removed protective layers to verify that none are left in the mold.
